(19) United States
(12) Patent Application Publication
(10) Pub. No.: US 2009/0243520 A1
(43) Pub. Date: Oct. 1, 2009

(54) Method for controlling operation of a linear vibration motor

(75) Inventors: Minoru Kashiwabara, Nakatsu (JP); Yasuo Ibuki, Hikone (JP)

Correspondence Address: BACON & THOMAS, PLLC, 625 SLATERS LANE, FOURTH FLOOR, ALEXANDRIA, VA, 22314-1176, US

(73) Assignee: Panasonic Electric Works Co., Ltd., Osaka (JP)

(21) Appl. No.: 12/382,705

(22) Filed: Mar. 23, 2009

(30) Foreign Application Priority Data
Mar. 26, 2008 (JP) 2008-081955

(51) Int. Cl. H02K 33/00

(52) U.S. Cl. 318/127

(57) ABSTRACT

A linear vibration motor includes a stator formed of an electromagnet with a winding, a vibrator provided with a permanent magnet and a control unit for controlling a driving current supplied to the winding of the electromagnet. The linear vibration motor is configured to reciprocate the vibrator relative to the stator. A method for controlling operation of the linear vibration motor includes: providing a non-energization period during which no driving current flows through the winding of the electromagnet, the non-energization period being equal to greater than a ¼ cycle; detecting an electromotive voltage induced in the winding as the vibrator makes vibrating movement within the non-energization period; detecting the displacement, velocity or acceleration of the vibrator based on the electromotive voltage thus detected; and controlling the driving current supplied to the winding based on the displacement, velocity or acceleration of the vibrator thus detected.

### FIELD OF THE INVENTION

The present invention relates to a method for controlling the operation of a linear vibration motor preferably applicable to a reciprocating electric shaver and designed to cause a movable body to make reciprocating movement.

### BACKGROUND OF THE INVENTION

Conventionally, there is known a linear vibration motor that includes a stator formed of an electromagnet or a permanent magnet, a vibrator provided with a permanent magnet or an electromagnet and a control unit for controlling the driving current supplied to the winding of the electromagnet, the vibrator being reciprocatingly vibrated relative to the stator. In the linear vibration motor, there is a need to detect the amplitude displacement, velocity and acceleration of the vibrator in order to keep the amplitude constant. In this viewpoint, the conventional linear vibration motor has a non-energization period during which to detect the amplitude displacement, velocity and acceleration of the vibrator (see, e.g., Japanese Patent Laid-open Publication No. 2001-16892).

The non-energization period needs to be shortened in case an attempt is made to efficiently feed an electric current to the winding of the electromagnet. In contrast, if an attempt is made to sufficiently lengthen the non-energization period, the timing at which an electric current is fed to the winding of the electromagnet becomes too late to efficiently supply the electric current. In order to detect the amplitude displacement, velocity and acceleration of the vibrator within a short period of time, it is necessary to perform operation control with a microcomputer that makes use of highly accurate external oscillation. This makes it difficult to save cost and to reduce the size of a circuit.

### SUMMARY OF THE INVENTION

In view of the above, the present invention provides a linear vibration motor operation control method capable of performing the operation control by which an electric current can be fed to a winding in a cost-effective and efficient manner.

In accordance with an aspect of the present invention, there is provided a method for controlling operation of a linear vibration motor including a stator formed of an electromagnet with a winding or a permanent magnet, a vibrator provided with a permanent magnet or an electromagnet with a winding and a control unit for controlling a driving current supplied to the winding of the electromagnet, the linear vibration motor being configured to reciprocate the vibrator relative to the stator, the method including: providing a non-energization period during which no driving current flows through the winding of the electromagnet, the non-energization period being equal to greater than a ¼ cycle; detecting an electromotive voltage induced in the winding as the vibrator makes vibrating movement within the non-energization period; detecting the displacement, velocity or acceleration of the vibrator based on the electromotive voltage thus detected; and optimally controlling the driving current supplied to the winding based on the displacement, velocity or acceleration of the vibrator thus detected and the current supplying timing.

With the linear vibration motor operation control method of the present invention, it is possible to perform the operation control by which an electric current can be fed to a winding in a cost-effective and efficient manner.

### BRIEF DESCRIPTION OF THE DRAWINGS

The objects and features of the present invention will become apparent from the following description of preferred embodiments, given in conjunction with the accompanying drawings, in which:

FIG. 1 is a block diagram showing a linear vibration motor in accordance with one embodiment of the present invention;

FIG. 2 is a circuit diagram showing an amplitude detection unit and a power supply circuit of the linear vibration motor shown in FIG. 1, wherein a reference voltage is adjusted depending on a battery voltage;

FIG. 3 is a waveform chart for explaining the timing for measurement of the electromotive voltage of a winding;

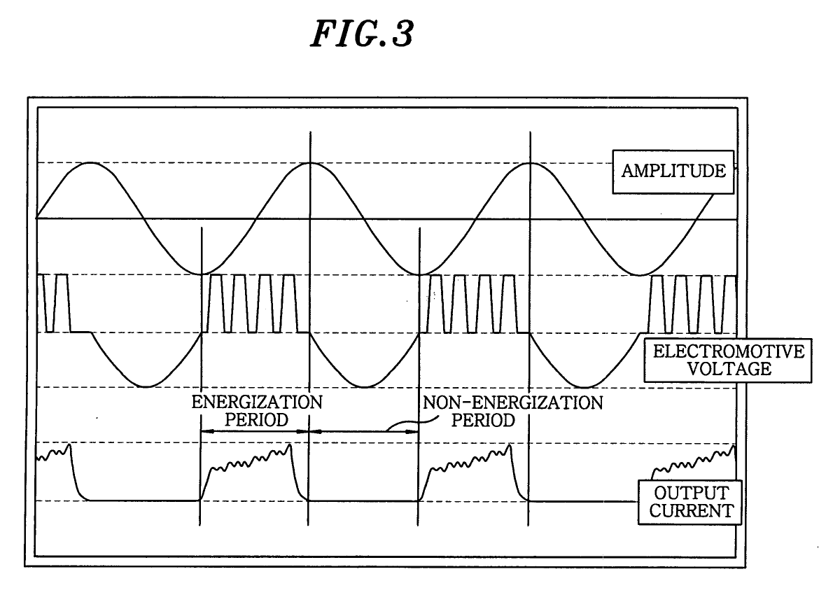

FIG. 4 is a circuit diagram showing a modified example of the power supply circuit shown in FIG. 2;

FIG. 5 is a waveform chart for explaining the timing for measurement of the electromotive voltage of a winding in the conventional linear vibration motor; and

FIG. 6 is a circuit diagram showing an amplitude detection unit and a power supply circuit of the linear vibration motor shown in FIG. 1, wherein a reference voltage is adjusted by a control output unit depending on a battery voltage.

### DETAILED DESCRIPTION OF THE PREFERRED EMBODIMENTS

Hereinafter, a linear vibration motor and a method for controlling the operation thereof in accordance with an embodiment of the present invention will be described with reference to the accompanying drawings which form a part hereof.

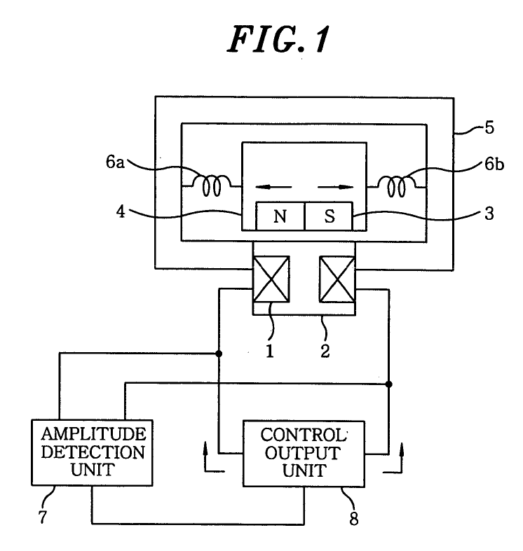

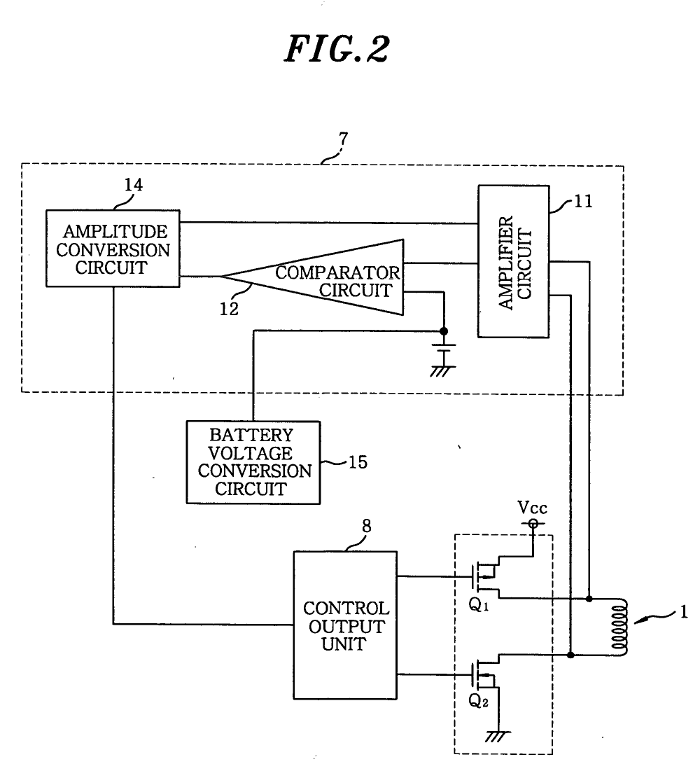

Referring to FIG. 1, a linear vibration motor in accordance with the embodiment of the present invention includes a stator 2 with a winding 1, a vibrator 4 with a permanent magnet 3, a frame 5 for holding the vibrator 4, springs 6a and 6b retained between the vibrator 4 and the frame 5, an amplitude detection unit 7 for detecting the vibration amplitude of the vibrator 4 based on the electromotive voltage induced in the winding 1 and a control output unit 8 for PWM (pulse width modulation)-controlling the driving current fed to the winding 1 based on the detection results of the amplitude detection unit 7. As shown in FIG. 2, the amplitude detection unit 7 includes an amplifier circuit 11 for amplifying the voltage between the opposite ends of the winding 1 and a comparator circuit 12 for comparing the amplified voltage with a reference voltage V0, i.e., a zero voltage. The time T0 when the amplified voltage becomes equal to the reference voltage V0 is regarded as a turning point of the vibration amplitude. The control output unit 8 sets a non-energization period in which the driving current does not flow through the winding 1 for a ¼ cycle or more from the turning point. The amplitude detection unit 7 further includes an amplitude conversion circuit 14 for periodically sampling the electromotive voltage of the winding 1 during this non-energization period and calculating the vibration amplitude using the maximum value of the sampled electromotive voltages.

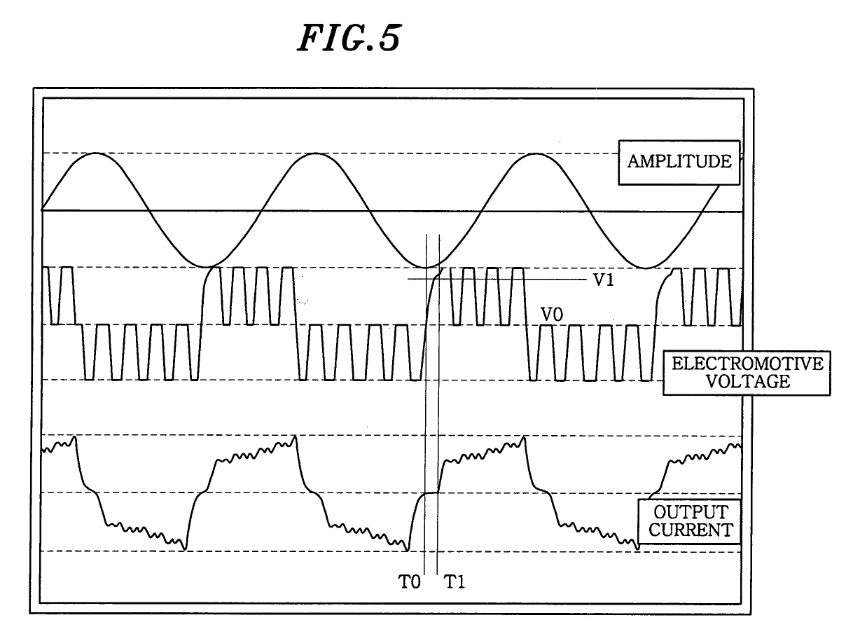

In the conventional linear vibration motor, as illustrated in FIG. 5, the vibration amplitude is detected based on the time difference between the time T0 at the turning point and the time T1 when the electromotive voltage becomes equal to a specified constant voltage V1. Since the time period for detection is too short, however, the conventional detection method is susceptible to measurement errors and is easily affected by noises, which reduces the detection accuracy. With the linear vibration motor in accordance with the present embodiment, the electromotive voltage of the winding 1 is periodically sampled by the amplitude conversion circuit 14 during the non-energization period and the vibration amplitude is calculated using the maximum value of the sampled electromotive voltages. Therefore, it is possible to reliably detect the vibration amplitude even if the sampling timing is deviated to some extent. Furthermore, an ample time is left before the winding 1 is energized again. With the linear vibration motor of the present embodiment, therefore, it is possible to energize the winding 1 in a timely manner, thereby efficiently operating the motor and saving the electric energy.

For efficient energization, it is preferred that the winding 1 is energized within a 1/20 cycle from the maximum displacement point or within a ¼ cycle from the maximum velocity point. It is also possible to energize the winding 1 at more accurate timing if the maximum amplitude point or the maximum velocity point is detected by a microcomputer. In case the microcomputer is used for control purposes, it is possible to accurately detect the vibration amplitude even if the sampling timing is deviated to some extent. Thanks to this feature, the linear vibration motor can be controlled more accurately than in the conventional case, even when use is made of an oscillation circuit with reduced accuracy or an oscillation clock built in the microcomputer.

Use of the microcomputer and prolongation of the non-energization period make it possible to set the period for detection of the maximum displacement point longer than in the conventional case. For example, the period for detection of the maximum displacement point may be set equal to 300 microseconds, which is longer than the conventional detection period by 100 microseconds or more. This makes it possible to control the linear vibration motor without missing the maximum displacement point even when the maximum displacement point is delayed by steep load variations.

It is typical that the driving current supplied to the winding 1 is PWM (pulse width modulation)-controlled through the use of upper and lower switching devices Q1 and Q2 (see FIG. 2) of an inverter circuit for energizing the winding 1. It is equally possible to WPWM (weighted pulse width modulation)-control the upper switching device Q1 in case of the control in which the non-energization period is one-half cycle. With this control, it is possible to have the switching timing for the motor remain the same and to supply an electric current at the efficient timing even when the current amount is adjusted according to the load variations.

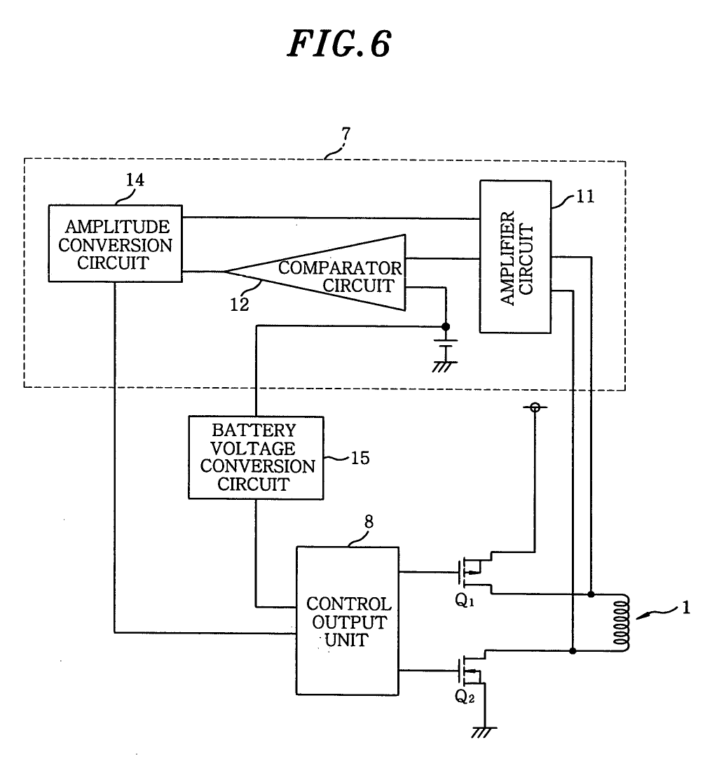

The voltage of a battery Vcc is detected on a real time basis by a battery voltage conversion circuit 15 shown in FIG. 6. Depending on the voltage thus detected, the control output unit 8 performs amplitude adjustment control. If the switching devices Q1 and Q2 are controlled in a uniform pattern regardless of the voltage, the electric current and the vibration amplitude would be increased when the battery voltage is high. With the afore-mentioned configuration by which to perform voltage feedback control, however, it is possible to control the vibration amplitude constant regardless of the voltage difference caused by the change in battery capacity.

Alternatively, as shown in FIG. 2, the amplitude variation resulting from the voltage of the battery Vcc may be suppressed by adjusting the reference voltage of the comparator circuit 12 with the battery voltage conversion circuit 15. If the control output unit 8 performs control in a uniform pattern regardless of the voltage, the electric current and the vibration amplitude would be increased when the battery voltage is high. In contrast, the electric current and the vibration amplitude would be decreased when the battery voltage is low. If the reference voltage is adjusted as above, however, the velocity of the vibrator detected is high when the battery voltage remains high. This makes it possible to perform velocity reduction control. On the other hand, the velocity of the vibrator detected is low when the battery voltage remains low. This makes it possible to perform velocity increasing control. Thanks to this feature, if the reference voltage is suitably adjusted, it becomes possible to cancel the influence of the battery voltage on the vibration amplitude and to control the vibration amplitude constant regardless of the difference in battery voltage.

In case the linear vibration motor is kept in a high-load state for a specified period of time, the maximum value of the electromotive voltage detected during the non-energization period becomes equal to or smaller than a predetermined reference voltage. This state is determined to be abnormal, in which case the operation of the linear vibration motor may be stopped. Alternatively, the abnormality may be determined by detecting whether an electric current greater than a specified reference value continues to flow through the winding 1.

If the linear vibration motor is suddenly stopped when the battery voltage is decreased to a value lower than the reference voltage, there is a possibility that the motor may be stopped with the hair strands of a mustache or a beard caught in, e.g., a shaving mechanism. To avoid such danger, it is preferable to slowly stop the motor by gradually reducing the duty ratio of the upper switching device Q1.

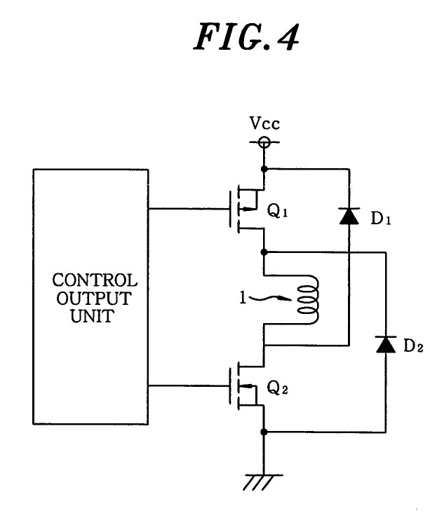

In case an electric current is supplied to the linear vibration motor in one direction, a half-bridge circuit provided with upper and lower switching devices Q1 and Q2 can be used as the inverter circuit for energizing the winding 1 as shown in FIG. 2. This makes it possible to reduce the number of switching devices, thereby saving cost and reducing size. FIG. 4 shows a half-bridge circuit. A diode D2 is arranged between the ground terminal of the half-bridge circuit and the plus terminal of the winding, while a diode D2 is arranged between the minus terminal of the winding 1 and the power source Vcc. By doing so, it is possible to allow an electric current to flow through the winding 1 again, thus operating the linear vibration motor in an efficient manner.

At this time, if the lower switching device Q2 is turned on for a time longer than one half cycle, it is possible to effectively use the electric current flowing through the winding 1 and to reduce the electric current flowing through the diode D1. This makes it possible to use low-priced component parts whose rating is low.

While the invention has been shown and described with respect to the preferred embodiments, it will be understood by those skilled in the art that various changes and modification may be made without departing from the scope of the invention as defined in the following claims. For example, the present invention may also be applied to an actuator including a movable stator that is not completely fixed.

What is claimed is:

1. A method for controlling operation of a linear vibration motor including a stator formed of an electromagnet with a winding or a permanent magnet, a vibrator provided with a permanent magnet or an electromagnet with a winding and a control unit for controlling a driving current supplied to the winding of the electromagnet, the linear vibration motor being configured to reciprocate the vibrator relative to the stator, the method comprising:
providing a non-energization period during which no driving current flows through the winding of the electromagnet, the non-energization period being equal to greater than a ¼ cycle;
detecting an electromotive voltage induced in the winding as the vibrator makes vibrating movement within the non-energization period;
detecting the displacement, velocity or acceleration of the vibrator based on the electromotive voltage thus detected; and
controlling the driving current supplied to the winding based on the displacement, velocity or acceleration of the vibrator thus detected.

2. The method of claim 1, wherein the maximum displacement point of the vibrator is taken as a reference point of the cycle, the driving current being supplied to the winding within a 1/20 cycle from the reference point.

3. The method of claim 1, wherein the maximum velocity point of the vibrator is taken as a reference point of the cycle, the driving current being supplied to the winding within a ¼ cycle from the reference point.

4. The method of claim 2, wherein the maximum displacement point of the vibrator is detected for a time period equal to or greater than 300 microseconds.

5. The method of claim 1, wherein the start timing and the end timing of an on-time period of a switching device that forms an inverter circuit for controlling the driving current supplied to the winding are kept constant, the switching operation of the switching device being controlled within the on-time.

6. The method of claim 1, wherein the voltage of a power source for supplying the driving current to the winding is detected within the non-energization period, the amplitude variation of the vibrator resulting from the change in the voltage of the power source being adjusted based on the detection result of the power source voltage.

7. The method of claim 1, wherein the reference voltage of a comparator circuit of an amplitude detection unit is adjusted using the non-energization period voltage of a power source for supplying the driving current to the winding, the amplitude variation of the vibrator being adjusted based on the adjusted reference voltage.

8. The method of claim 1, wherein the linear vibration motor is stopped if the maximum value of an electromotive voltage detected within the non-energization period continues to be equal to or smaller than a predetermined value for a specified time or more.

9. The method of claim 1, wherein the linear vibration motor is stopped if a driving current equal to or greater than a predetermined value continues to flow through the winding for a specified time or more.

10. The method of claim 1, wherein, if the voltage of a power source for supplying the driving current to the winding is equal to or smaller than a predetermined value, the linear vibration motor is slowly stopped by gradually reducing the duty ratio of a switching device that forms an inverter circuit for controlling the driving current supplied to the winding.

11. The method of claim 1, wherein a half-bridge circuit including a pair of upper and lower switching devices is used as an inverter circuit for controlling the driving current supplied to the winding.

12. The method of claim 11, wherein a first diode is arranged between a ground level of the half-bridge circuit and a plus terminal of the winding, and a second diode is arranged between a power source and a minus terminal of the winding.

13. The method of claim 11, wherein the lower switching device is energized for a time period greater than one half cycle.

14. The method of claim 12, wherein the lower switching device is energized for a time period greater than one half cycle.
